(19) United States
(12) Patent Application Publication
(10) Pub. No.: US 2019/0182654 A1
(43) Pub. Date: Jun. 13, 2019

(54) PREVENTING COVERT CHANNEL BETWEEN USER EQUIPMENT AND HOME NETWORK IN COMMUNICATION SYSTEM

(71) Applicant: Nokia Technologies Oy, Espoo (FI)

(72) Inventors: Anja Jerichow, Grafing (DE); Suresh Nair, Whippany, NJ (US)

(73) Assignee: Nokia Technologies Oy, Espoo (FI)

(21) Appl. No.: 15/836,153

(22) Filed: Dec. 8, 2017

(51) Int. Cl. H04W 8/04; H04W 8/18; H04L 9/32; H04L 9/06; H04L 29/06

(52) U.S. Cl. CPC H04W 8/04; H04W 8/183; H04L 9/3213; H04W 12/06; H04L 9/0643; H04L 63/1483; H04L 9/3242

(57) ABSTRACT

Illustrative embodiments provide subscriber privacy management techniques that prevent a covert channel from being established between user equipment and a home network through a serving network in a communication system. In one example, a random value is computed in the serving network and added to the registration request procedure. The techniques also enable the home network to control UE behavior using an authorization token.

### FIELD

The field relates generally to communication systems, and more particularly, but not exclusively, to subscriber privacy management techniques within such systems.

### BACKGROUND

This section introduces aspects that may be helpful to facilitating a better understanding of the inventions. Accordingly, the statements of this section are to be read in this light and are not to be understood as admissions about what is in the prior art or what is not in the prior art.

Fourth generation (4G) wireless mobile telecommunications technology, also known as Long Term Evolution (LTE) technology, was designed to provide high capacity mobile multimedia with high data rates particularly for human interaction. Next generation or fifth generation (5G) technology is intended to be used not only for human interaction, but also for machine type communications in so-called Internet of Things (IoT) networks.

While 5G networks are intended to enable massive IoT services (e.g., very large numbers of limited capacity devices) and mission-critical IoT services (e.g., requiring high reliability), improvements over legacy mobile communication services are supported in the form of enhanced mobile broadband (eMBB) services providing improved wireless Internet access for mobile devices.

In an example communication system, user equipment (5G UE in a 5G network or, more broadly, a UE) such as a mobile terminal (subscriber) communicates over an air interface with a base station or access point referred to as a gNB in a 5G network. The access point (e.g., gNB) is illustratively part of an access network of the communication system. For example, in a 5G network, the access network is referred to as a 5G System and is described in 5G Technical Specification (TS) 23.501, V1.5.0, entitled “Technical Specification Group Services and System Aspects; System Architecture for the 5G System,” the disclosure of which is incorporated by reference herein in its entirety. In general, the access point (e.g., gNB) provides access for the UE to a core network (CN), which then provides access for the UE to other UEs and/or a data network such as a packet data network (e.g., Internet).

Privacy is an important consideration in any communication system. Privacy is broadly addressed in 5G Technical Report (TR) 33.899, V1.1.0, entitled “3rd Generation Partnership Project; Technical Specification Group Services and System Aspects; Study on the security aspects of the next generation system (Release 14),” the disclosure of which is incorporated by reference herein in its entirety. In particular, TR 33.899 identifies subscription (UE) privacy as one of the most important security areas to be addressed in 5G networks. 5G Technical Specification (TS) 33.501, V0.3.0, entitled “3rd Generation Partnership Project; Technical Specification Group Services and System Aspects; Security Architecture and Procedures for 5G System (Release 15),” the disclosure of which is incorporated by reference herein in its entirety, provides the normative security description.

However, existing UE privacy procedures in a 5G network may be susceptible to misuse under certain scenarios.

### SUMMARY

Illustrative embodiments provide improved techniques for managing subscriber privacy in communication systems.

For example, in one illustrative embodiment, a method comprises the following steps. In a serving network of a communication system that also comprises at least one home network associated with a set of subscribers wherein one or more cryptographic key pairs are provisioned for utilization by the subscribers of the home network to conceal subscriber identifiers provided to one or more access points in the serving network of the communication system, an access and mobility management entity of the serving network is configured to perform steps of: receiving a registration request from user equipment associated with a given subscriber of the home network, the registration request comprising a concealed subscriber identifier for the given subscriber; computing a random value; applying a cryptographic hash function to the concealed subscriber identifier and the random value to generate a hash value; sending the hash value to the home network with an authorization request; receiving a response to the authorization request from the home network, wherein the response comprises an authorization token; and sending a message to the user equipment comprising the random value and the authorization token.

In another illustrative embodiment, a method comprises the following steps. In a serving network of a communication system that also comprises at least one home network associated with a set of subscribers wherein one or more cryptographic key pairs are provisioned for utilization by the subscribers of the home network to conceal subscriber identifiers provided to one or more access points in the serving network of the communication system, user equipment associated with a given subscriber of the home network is configured to perform steps of: sending a registration request to an access and mobility management entity of the serving network, the registration request comprising a concealed subscriber identifier for the given subscriber; receiving a message from the access and mobility management entity comprising a random value computed by the access and mobility management entity and an authorization token provided by the home network; computing a hash value using a cryptographic hash function applied to the concealed subscriber identifier and the random value; checking that the hash value is part of the authorization token provided by the home network; and proceeding based on authorization information from the authorization token.

In a further illustrative embodiment, a method comprises the following steps. In a serving network of a communication system that also comprises at least one home network associated with a set of subscribers wherein one or more cryptographic key pairs are provisioned for utilization by the subscribers of the home network to conceal subscriber identifiers provided to one or more access points in the serving network of the communication system, an authentication entity in the home network is configured to perform steps of: receiving a hash value with an authorization request for user equipment associated with a given subscriber from an access and mobility management entity of the serving network, wherein the hash value was computed at the access and mobility management entity using a cryptographic hash function applied to a concealed subscriber identifier associated with the user equipment and a random value computed at the access and mobility management entity; computing an authorization token comprising authorization information; and sending a response to the authorization request to the access and mobility management entity of the serving network, wherein the response comprises the authorization token cryptographically signed by the home network.

Advantageously, illustrative embodiments enable subscriber privacy management techniques that prevent a covert channel from being established between user equipment and a home network through the serving network, and that also enable a way for the home network to control the UE behavior.

Further embodiments are provided in the form of non-transitory computer-readable storage medium having embodied therein executable program code that when executed by a processor causes the processor to perform the above steps. Still further embodiments comprise apparatus with a processor and a memory configured to perform the above steps.

These and other features and advantages of embodiments described herein will become more apparent from the accompanying drawings and the following detailed description.

### BRIEF DESCRIPTION OF THE DRAWINGS

FIG. 1 is a block diagram of a communication system, according to an illustrative embodiment.

FIG. 2 is a block diagram of network elements/functions for providing subscriber privacy management, according to an illustrative embodiment.

FIG. 3 shows a message flow for a procedure for managing subscriber privacy that enables a covert channel between user equipment and a home network.

FIG. 4 shows a message flow for a procedure for managing subscriber privacy that prevents a covert channel between user equipment and a home network, according to an illustrative embodiment.

FIG. 5 shows a message flow for a procedure for managing subscriber privacy that prevents a covert channel between user equipment and a home network and wherein the home network gives further guidance to the roaming user equipment on network selection policies in the serving network, according to an illustrative embodiment.

### DETAILED DESCRIPTION

Embodiments will be illustrated herein in conjunction with example communication systems and associated techniques for providing subscriber privacy management in communication systems. It should be understood, however, that the scope of the claims is not limited to particular types of communication systems and/or processes disclosed.

Embodiments can be implemented in a wide variety of other types of communication systems, using alternative processes and operations. For example, although illustrated in the context of wireless cellular systems utilizing 3GPP system elements such as a 3GPP next generation system (5G), the disclosed embodiments can be adapted in a straightforward manner to a variety of other types of communication systems including, but not limited to, WiMAX systems and Wi-Fi systems.

In accordance with illustrative embodiments implemented in a 5G communication system environment, one or more of the following 3GPP technical specifications (TS) and technical reports (TR) may provide further explanation of network elements/functions and/or operations that may interact with parts of the inventive solutions: 3GPP TS 23.501, 3GPP TS 23.502, 3GPP TS 33.501, and 3GPP TR 33.899, the disclosures of which are incorporated by reference herein in their entireties. Other 3GPP TS/TR documents may provide other conventional details that one of ordinary skill in the art will realize. However, while well-suited for 5G-related 3GPP standards, embodiments are not necessarily intended to be limited to any particular standards.

As mentioned above, privacy of subscription identifiers when communicated over the air interface between the user equipment and the network access point has been a significant issue for communication systems. Efforts have been made in 5G networks to address this significant issue.

For example, it is known that malicious actors attempt to learn subscriber identifiers either by passively (passive catcher) eavesdropping over the air interface between the UE and the gNB or actively (active catcher) requesting the subscriber identifier.

Solutions to provide privacy over the air interface can be generally grouped in three solution classes: (1) pseudonym solutions based on symmetric cryptographic systems, which demand a home subscriber server/function of the UE's home network to map a changing pseudonym to the permanent subscription identifier of the UE; (2) encryption of the permanent subscription identifier of the UE using the public key of the home network operator; and (3) encryption of the permanent subscription identifier of the UE using the public key of the serving network operator.

While embodiments can be adapted for any of the above-mentioned solutions, illustrative embodiments provide subscriber privacy management techniques from the perspective of solution 2 (encryption of the permanent subscription identifier of the UE using the public key of the home network operator).

Note that, in one example, an International Mobile Subscriber Identity (IMSI) is a permanent subscription identifier (subscriber identity) of a UE. In one embodiment, the IMSI is a fixed 15-digit length and consists of a 3-digit Mobile Country Code (MCC), a 3-digit Mobile Network Code (MNC), and a 9-digit Mobile Station Identification Number (MSIN).

In a 5G communication system, an IMSI is referred to as a Subscription Permanent Identifier (SUPI). In the case of an IMSI as a SUPI, the MSIN provides the subscriber identity. Thus, only the MSIN portion of the IMSI needs to be encrypted. The MNC and MCC portions of the IMSI provide routing information, used by the serving network to route to the correct home network. The encryption-protected SUPI is called a Subscription Concealed Identifier (SUCI). The home network operator (mobile network operator or MNO) generates one or more public/private key pairs for the purpose of enabling concealment of the SUPI. The public key of a given key pair is provisioned to all MNO subscribers and is used to conceal the SUPI. Only the MNO can de-conceal the SUPI, since the MNO has the corresponding private key. SUPIs are typically maintained in the User Data Management/User Data Repository (UDM/UDR) and managed by the MNO. An MNO can have several UDM instances accessible through a UDM front end, each of them relating to a distinct set of subscribers. In addition, an MNO may have contracted resources to a Mobile Virtual Network Operator (MVNO), which also may have an allocated part of the UDM.

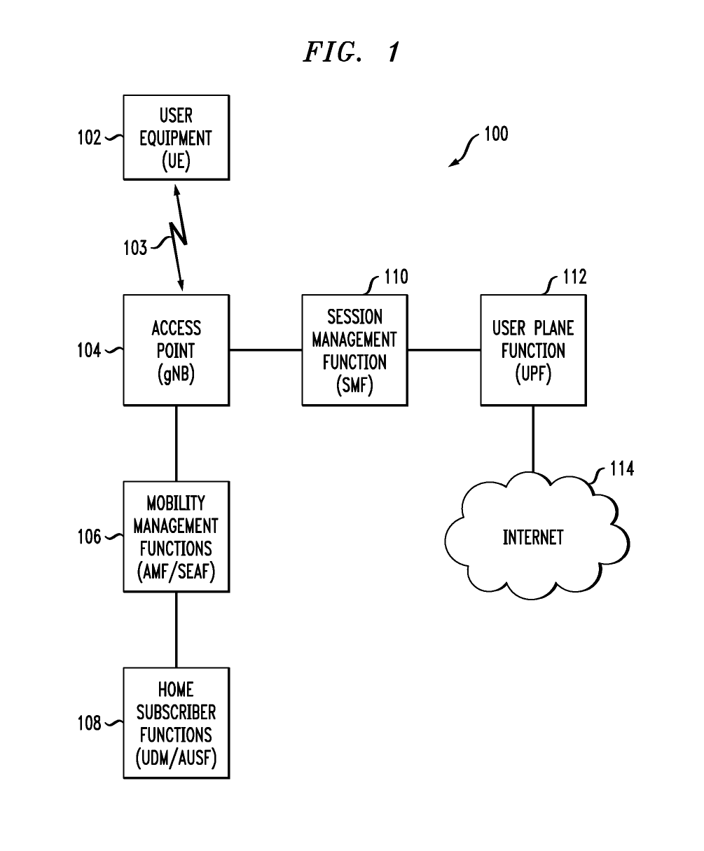

FIG. 1 shows a communication system 100 within which illustrative embodiments are implemented. It is to be understood that the elements shown in communication system 100 are intended to represent main functions provided within the system, e.g., UE access functions, mobility management functions, authentication functions, serving gateway functions, etc. As such, the blocks shown in FIG. 1 reference specific elements in 5G networks that provide these main functions. However, other network elements may be used to implement some or all of the main functions represented. Also, it is to be understood that not all functions of a 5G network are depicted in FIG. 1. Rather, functions that facilitate an explanation of illustrative embodiments are represented. Subsequent figures may depict some additional elements/functions.

Accordingly, as shown, communication system 100 comprises user equipment (UE) 102 that communicates via an air interface 103 with an access point (gNB) 104. The UE 102 may be a mobile station, and such a mobile station may comprise, by way of example, a mobile telephone, a computer, or any other type of communication device. The term “user equipment” as used herein is therefore intended to be construed broadly, so as to encompass a variety of different types of mobile stations, subscriber stations or, more generally, communication devices, including examples such as a combination of a data card inserted in a laptop or other equipment such as a smart phone. Such communication devices are also intended to encompass devices commonly referred to as access terminals.

In one embodiment, UE 102 is comprised of a Universal Integrated Circuit Card (UICC) part and a Mobile Equipment (ME) part. The UICC is the user-dependent part of the UE and contains at least one Universal Subscriber Identity Module (USIM) and appropriate application software. The USIM securely stores the SUPI (IMSI) and its related key, which are used to identify and authenticate subscribers to access networks. The ME is the user-independent part of the UE and contains terminal equipment (TE) functions and various mobile termination (MT) functions.

The access point 104 is illustratively part of an access network of the communication system 100. Such an access network may comprise, for example, a 5G System having a plurality of base stations and one or more associated radio network control functions. The base stations and radio network control functions may be logically separate entities, but in a given embodiment may be implemented in the same physical network element, such as, for example, a base station router or femto cellular access point.

The access point 104 in this illustrative embodiment is operatively coupled to mobility management functions 106. In a 5G network, the mobility management function is implemented by an Access and Mobility Management Function (AMF). A Security Anchor Function (SEAF) can also be implemented with the AMF connecting a UE with the mobility management function. A mobility management function, as used herein, is the element or function (i.e., entity) in the core network (CN) part of the communication system that manages or otherwise participates in, among other network operations, access and mobility (including authentication/authorization) operations with the UE (through the access point 104). The AMF may also be referred to herein, more generally, as an access and mobility management entity.

The AMF 106 in this illustrative embodiment is operatively coupled to home subscriber functions 108, i.e., one or more functions that are resident in the home network of the subscriber. As shown, some of these functions include the above-mentioned UDM function, as well as an Authentication Server Function (AUSF). The AUSF and UDM (separately or collectively) may also be referred to herein, more generally, as an authentication entity.

The access point 104 is also operatively coupled to a serving gateway function 110 (e.g., Session Management Function (SMF) in a 5G network), which is operatively coupled to a User Plane Function (UPF) 112. UPF 112 is operatively coupled to a Packet Data Network, e.g., Internet 114. Further typical operations and functions of such network elements are not described here since they are not the focus of the illustrative embodiments and may be found in appropriate 3GPP 5G documentation.

It is to be appreciated that this particular arrangement of system elements is an example only, and other types and arrangements of additional or alternative elements can be used to implement a communication system in other embodiments. For example, in other embodiments, the system 100 may comprise other elements/functions not expressly shown herein.

Accordingly, the FIG. 1 arrangement is just one example configuration of a wireless cellular system, and numerous alternative configurations of system elements may be used. For example, although only single UE, gNB, AMF, SEAF, AUSF, UDM, SMF and UPF elements are shown in the FIG. 1 embodiment, this is for simplicity and clarity of description only. A given alternative embodiment may of course include larger numbers of such system elements, as well as additional or alternative elements of a type commonly associated with conventional system implementations.

It is also to be noted that while FIG. 1 illustrates system elements as singular functional blocks, the various subnetworks that make up the 5G network are partitioned into so-called network slices. Network slices (network partitions) comprise a series of function sets (i.e., function chains) for each corresponding service type using network function virtualization (NFV) on a common physical infrastructure. The network slices are instantiated as needed for a given service, e.g., eMBB service, massive IoT service, and mission-critical IoT service. A network slice or function is thus instantiated when an instance of that network slice or function is created. In some embodiments, this involves installing or otherwise running the network slice or function on one or more host devices of the underlying physical infrastructure. UE 102 is configured to access one or more of these services via gNB 104.

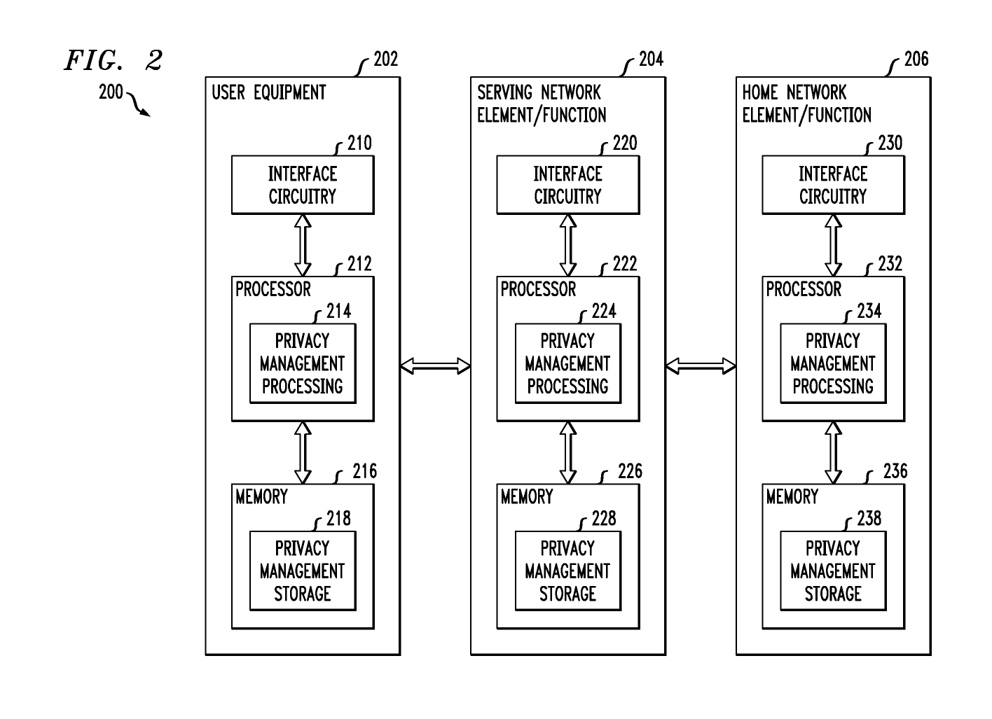

FIG. 2 is a block diagram of user equipment and network elements/functions for providing subscriber privacy management in an illustrative embodiment. System 200 is shown comprising user equipment (UE) 202, a serving (visiting) network (SN) element/function 204 and a home network (HN) element/function 206. For example, in illustrative embodiments, the SN network element/function 204 can represent AMF/SEAF functions, while the HN element/function 206 can represent UDM/AUSF functions. It is to be appreciated that the UE 202 and the network elements/functions 204 and 206 are configured to provide subscriber privacy management and other techniques described herein.

The user equipment 202 comprises a processor 212 coupled to a memory 216 and interface circuitry 210. The processor 212 of the user equipment 202 includes a privacy management processing module 214 that may be implemented at least in part in the form of software executed by the processor. The processing module 214 performs privacy management described in conjunction with subsequent figures and otherwise herein. The memory 216 of the user equipment 202 includes a privacy management storage module 218 that stores data generated or otherwise used during privacy management operations.

The serving network element/function 204 comprises a processor 222 coupled to a memory 226 and interface circuitry 220. The processor 222 of the serving network element/function 204 includes a privacy management processing module 224 that may be implemented at least in part in the form of software executed by the processor 222. The processing module 224 performs privacy management described in conjunction with subsequent figures and otherwise herein. The memory 226 of the serving network element/function 204 includes a privacy management storage module 228 that stores data generated or otherwise used during privacy management operations.

The home network element/function 206 comprises a processor 232 coupled to a memory 236 and interface circuitry 230. The processor 232 of the home network element/function 206 includes a privacy management processing module 234 that may be implemented at least in part in the form of software executed by the processor 232. The processing module 234 performs privacy management described in conjunction with subsequent figures and otherwise herein. The memory 236 of the home network element/function 206 includes a privacy management storage module 238 that stores data generated or otherwise used during privacy management operations.

The processors 212, 222, and 232 of the respective user equipment and network elements/functions 202, 204, and 206 may comprise, for example, microprocessors, application-specific integrated circuits (ASICs), digital signal processors (DSPs) or other types of processing devices, as well as portions or combinations of such elements.

The memories 216, 226, and 236 of the respective user equipment and network elements/functions 202, 204, and 206 may be used to store one or more software programs that are executed by the respective processors 212, 222, and 232 to implement at least a portion of the functionality described herein. For example, subscriber privacy management operations and other functionality as described in conjunction with subsequent figures and otherwise herein may be implemented in a straightforward manner using software code executed by processors 212, 222, and 232.

A given one of the memories 216, 226, or 236 may therefore be viewed as an example of what is more generally referred to herein as a computer program product or still more generally as a processor-readable storage medium that has executable program code embodied therein. Other examples of processor-readable storage media may include disks or other types of magnetic or optical media, in any combination. Illustrative embodiments can include articles of manufacture comprising such computer program products or other processor-readable storage media.

The memory 216, 226, or 236 may more particularly comprise, for example, an electronic random-access memory (RAM) such as static RAM (SRAM), dynamic RAM (DRAM) or other types of volatile or non-volatile electronic memory. The latter may include, for example, non-volatile memories such as flash memory, magnetic RAM (MRAM), phase-change RAM (PC-RAM) or ferroelectric RAM (FRAM). The term “memory” as used herein is intended to be broadly construed, and may additionally or alternatively encompass, for example, a read-only memory (ROM), a disk-based memory, or other type of storage device, as well as portions or combinations of such devices.

The interface circuitries 210, 220, and 230 of the respective user equipment and network elements/functions 202, 204, and 206 illustratively comprise transceivers or other communication hardware or firmware that allows the associated system elements to communicate with one another in the manner described herein.

It is apparent from FIG. 2 that user equipment 202 and the network elements/functions 204 and 206 are configured for communication with each other via their respective interface circuitries 210, 220, and 230. This communication involves user equipment 202 sending data to and receiving data from the serving network element/function 204, and the serving network element/function 204 sending data to and receiving data from the home network element/function 206. However, in alternative embodiments, other network elements may be operatively coupled between or to the user equipment 202 and/or the network elements/functions 204 and 206. The term “data” as used herein is intended to be construed broadly, so as to encompass any type of information that may be sent between network elements/functions, as well as between user equipment and such network elements/functions, including, but not limited to, identity data, key pairs, key indicators, registration request/response messages and data, authentication request/response messages and data, control data, audio, video, multimedia, other messages, etc.

It is to be appreciated that the particular arrangement of components shown in FIG. 2 is an example only, and numerous alternative configurations may be used in other embodiments. For example, any given network element/function can be configured to incorporate additional or alternative components and to support other communication protocols.

Other system elements such as gNB 104, SMF 110, and UPF 112 may each be configured to include components such as a processor, memory and network interface. These elements need not be implemented on separate stand-alone processing platforms, but could instead, for example, represent different functional portions of a single common processing platform.

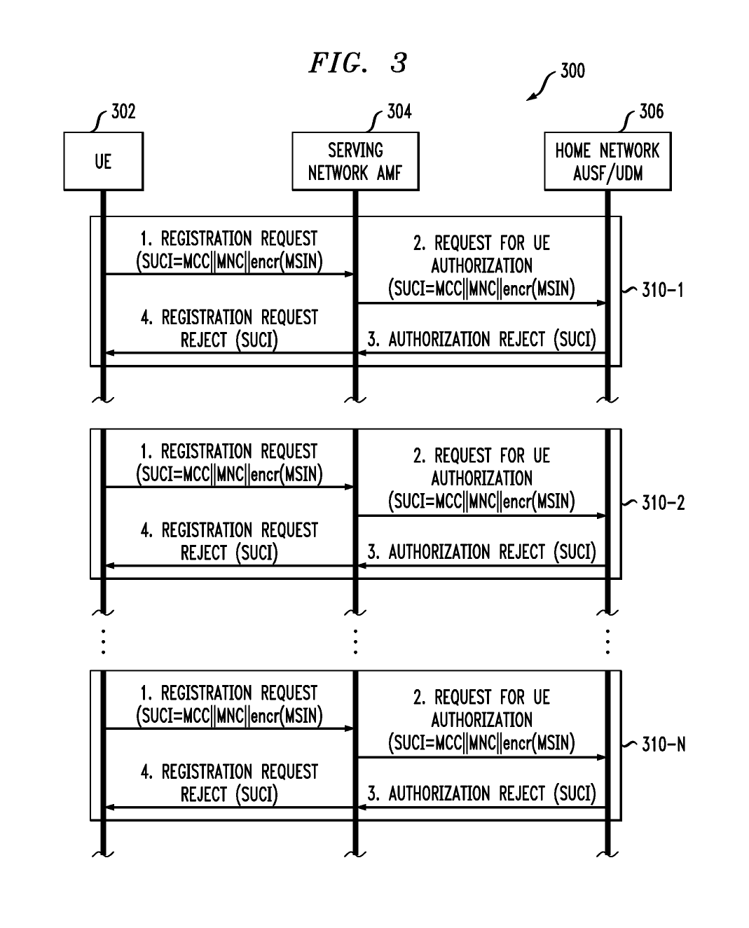

Given the above illustrative 5G system configuration, in a roaming scenario, the UE sends a Registration Request message to the AMF of a Serving Network (SN) with the SUCI of the UE included as the identifier. In response, the SN (AMF) sends an Authentication Request message to authenticate the UE to the AUSF/UDM of the Home Network (HN) identified by the MMC+MNC part of the SUCI. If the authentication process is not complete and vectors are not generated, the UE can repeat the Registration Request multiple times and the SN is expected to forward/send the Authentication Request message each time to the HN when it receives a Registration Request from the UE. This scenario is illustrated in message flow 300 in FIG. 3 with respect to UE 302, serving network AMF 304, and home network AUSF/UDM 306. Note that the message sequence of: registration request, request for UE authorization, authorization reject, and registration request reject, is repeated multiple times, i.e., 310-1, 310-2, . . . 310-N.

This scenario poses a potential misuse issue in the form of a collusion opportunity for the UE 302 and the home network or HN (AUSF/UDM) 306. That is, by the multiple rejected registration requests, the UE and the HN can establish a covert channel to communicate between them with the serving network or SN 304 watching the exchange transparently. For example, the UE and the HN could have agreed on a very limiting protection scheme that allows to generate only a very limited set of SUCIs which would give the UE the option to secretly provide information to the HN. But this is only part of the problem. Similarly, the MSIN part of the SUCI in the message could contain a secret between the UE and the HN.

It has been proposed that the SN could forbid sending a SUCI with the MSIN encrypted and the SN could request the SUPI from the UE instead. A null-scheme has been introduced for this purpose, i.e., keeping the same format as for a real-encrypted SUCI, but the MSIN part is sent unencrypted. But even with such a null-SUCI, the covert channel problem is still present. That is, assume that that a null-SUCI request from the SN to the UE must first be authorized by the HN (HN null-SUCI authorization scenario). Even if SUCI or any other fresh value is hashed (a cryptographic hash function is applied) before sending the authorization request message to the HN, it is still possible for the UE to use it as covert channel.

For example, assume that SN requests the UE to send a null-scheme SUCI (null-SUCI), i.e., MSIN would be sent unprotected, it could be possible to employ the following scheme to set up a covert channel between the UE and the HN when sending a SUCI to the HN. The scheme is as follows:

(i) UE and HN agree on a limited number of SUCIs.

(ii) SN does not trust any encryption since it suspects a covert channel between UE and HN, therefore UE is requested to send null-SUCI.

(iii) UE and HN agree offline on a potentially large, but somehow limited, set of messages M1, M2, . . . , Mm that they want to exchange secretly.

(iv) UE and HN also agree on a seed S for a PRNG (Pseudo Random Number Generator) so that they can generate a sequence of pseudo random numbers R1, R2, . . . , Rn in a deterministic fashion.

(v) UE and HN also agree on an encryption function Enc.

(vi) UE and HN then compute a table of values [Mi, H(Enc(Rj; Mi))], where M is the i^{th} message, H is the hash function applied by SN, and Rj is used as the key for the encryption function Enc.

(vii) As the Rj are pseudo random numbers, the function Enc could, for example, simply be realized as Enc(Rj; Mi)=Rj XOR Mi.

Thus, in a scenario where authorization proof from HN is required before the UE will send null-SUCI, the procedure would then be as follows:

(i) UE wants to send a secret message Mi to HN.

(ii) For this purpose, UE generates a Rj and sends Fresh=Mi Enc(Rj; Mi) to the SN.

(iii) SN computes H(Fresh) and sends it to HN.

(iv) HN looks up the table to find Mi.

Accordingly, the UE and the HN effectively have established a covert channel with the SN merely being a transparent forwarding entity.

Illustrative embodiments overcome the above and other problems by preventing a covert channel from being established between the UE to the HN. As will be explained in illustrative detail below, this is accomplished by enabling the SN to intervene by performing more than just a hash operation of the input provided by UE.

In one illustrative embodiment, the SN AMF inserts itself into the exchange between the UE and its HN by calculating its own token using as input its own fresh value (Rand_SN). Unless the SN AMF gives this token to the UE, the UE will not be able to verify the Response message from the HN.

The SN, instead of simply hashing any value (e.g., SUCI or freshness value ‘Fresh’) that it receives from the UE, and forwarding H(Fresh) to the HN, illustrative embodiments have the SN (AMF) generate a random number of its own and add it to Fresh before generating the hash.

So, SN now computes H(Fresh, Rand_SN) and sends it to HN. Note, the UE provided key identifier needs to be sent to the HN as well, otherwise the HN could not sign any response (=authorization info), since it does not know which public key is known by the UE.

HN computes an authorization token by signing (authorization info∥H(Fresh, Rand_SN)) with the private key corresponding to the key identifier and sends the token back to SN.

SN forwards the token and in addition Rand_SN to UE.

UE computes the hash H(Fresh, Rand_SN) from its own input Fresh value and received Rand_SN. UE checks for the presence of H(Fresh, Rand_SN) and verifies the signature on the token.

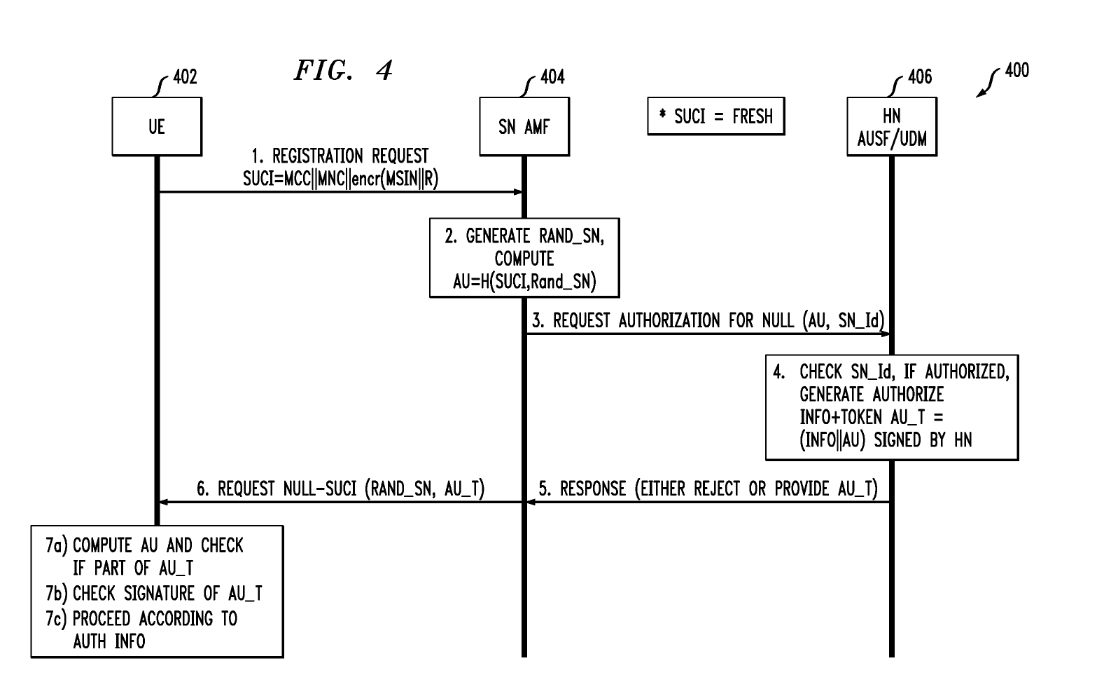

Thus, the method of HN authorization which hashes the Fresh value received from the UE can now be used without fear of a covert channel by the Fresh value, since the inclusion of Rand_SN makes it very difficult to transport any unwanted information between the UE and the HN. This procedure is illustrated in FIG. 4.

FIG. 4 shows a message flow 400 for a procedure for managing subscriber privacy that prevents a covert channel between user equipment and a home network in an illustrative embodiment. As shown:

1. UE 402 sends Registration Request to the SN AMF 404 including SUCI (i.e., in roaming scenario).

2. If a Registration Request is received from a UE belonging to a HN, the AMF 404 belonging to SN inserts itself into the communication. The SN AMF 404 computes a random number Rand_SN and computes a token AU, AU=H(SUCI, Rand_SN).

3. SN AMF 404 sends the HN AUSF/UDM 406 a Request for UE Authentication/Authorization by including (AU, SN_Id), where SN_Id is the identifier for the Serving Network (SN).

4. The AUSF/UDM 406 belonging to the HN checks whether SN is authorized to generate the token AU. If it is authorized, it generates Authorization info, Token AU_T=(info∥AU) signed by the HN.

5. The HN AUSF/UDM 406 sends a Response to UE Authorization Request to the SN, instructing the SN either to reject or provide AU_T.

6. The SN AMF 404 sends the UE 402 a Registration Request Response message asking the UE 402 to provide its NULL-SUCI (i.e., non-encrypted SUPI). The message also contains (Rand_SN and AU_T).

7. The UE 402 computes AU as the AMF 404 did in step 2 using Rand_SN, and checks if it is part of AU_T. UE 402 verifies the AU_T it computed with the AU_T received. The compute and verify sub-steps can be done in the opposite order. UE 402 then proceeds with information it received in the Registration Request response.

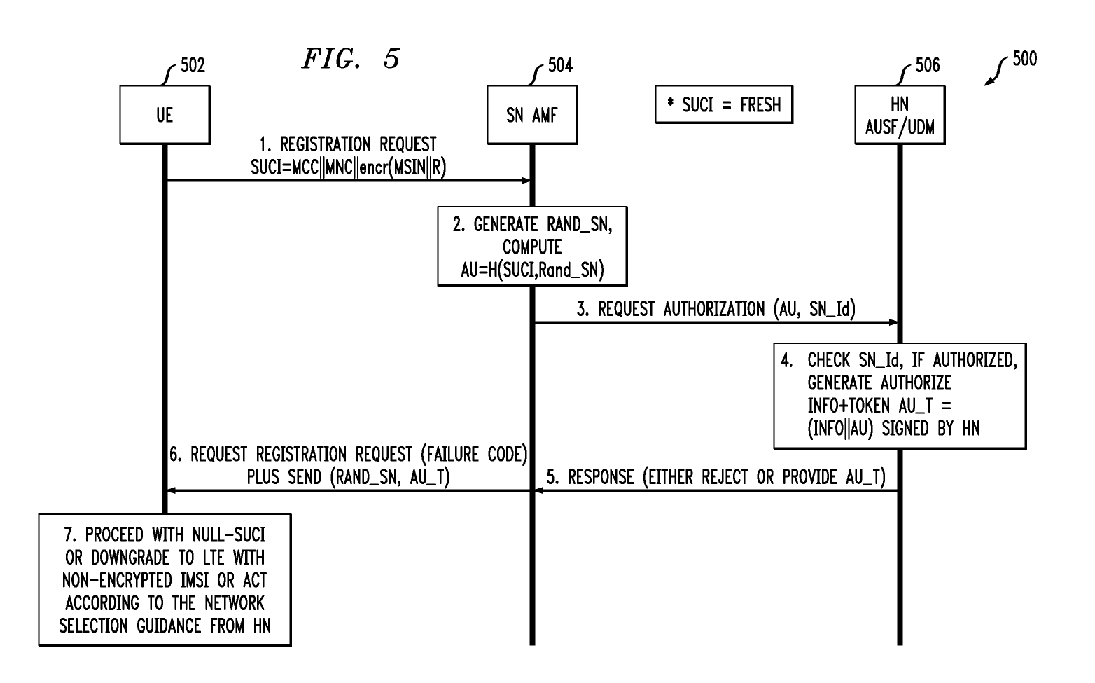

FIG. 5 shows a message flow 500 for a procedure for managing subscriber privacy that prevents a covert channel between user equipment and a home network in another illustrative embodiment where the home network gives further guidance to the roaming UE on network selection policies in the SN.

It is to be appreciated that the message flow 500 in FIG. 5 is very similar to the message flow in FIG. 4. Thus, steps 1-2, 4, 5 and 7 in FIG. 5 with respect to UE 502, SN AMF 504, and HN AUSF/UDM 506 are the same as or similar to steps 1-2, 4, 5 and 7 in FIG. 4 with respect to UE 402, SN AMF 404, and HN AUSF/UDM 406. The main distinction is with regard to steps 3 and 6. Rather than requesting null-scheme authorization from the HN, the SN requests in step 3 authorized guidance from the HN in general, since SN plans to reject the original UE registration request, e.g., it does not want to process the registration request with an encrypted SUPI and wants the UE to do an LTE initial attach with IMSI instead. Then, rather than requesting the UE to provide its null-SUCI (non-encrypted SUPI) as in step 6 of FIG. 4, step 6 in FIG. 5 has the SN AMF 504 send the UE 502 a registration request reject with a failure code and provide the authorization from HN 506 to either deny service to the UE or to use null-scheme or to give guidance on network selection policies in the SN such as downgrade to LTE (legacy security mode), or select particular WiFi SSD, etc., based on service level agreements (SLA) between the HN and SN. The UE 502 then can proceed with the authorization, e.g., above-mentioned null-SUCI scheme or act according to instructed network selection policy such as downgrade to LTE using non-encrypted IMSI.

Thus, it is realized that if the SN rejects the UE registration request, there are several options. For example, the UE has no service at all, the UE attempts with null-scheme, or the UE downgrades to LTE and attaches using LTE initial attach procedure (to the LTE network of SN), thus SUPI=IMSI not protected. Alternatively, the UE can act based on the network selection guidance it received from the HN.

The UE is a 5G UE and the SN has previously demonstrated that it is configured as a 5G system (otherwise the UE would not have tried registration request with SUPI at all). If the SN is blocking (rejecting) the registration request, the SN will give a cause for doing so. Thus, the SN could be mandated to obtain HN authorization, as described above, to send a failure code back to the UE including the authorization token which, e.g., allows the UE to attach with LTE or with null-scheme. This approach can be used for allowing HN-controlled downgrading to LTE and thus avoid the covert channel in HN authorization for HN-controlled change of UE behavior.

Additionally or alternatively, if the UE 502 sends a null-SUCI (as configured by HN), but the SN would like to protect all subscribers equally, the SN (AMF 504) could also get the authorization from the HN (AUSF/UDM 506) that the UE shall use encrypted-SUCI.

Still further, additionally or alternatively, if the authorization verification fails at the UE 502, the UE 502 can abandon the entire registration procedure in the SN. That is because, in such a scenario, the HN has not permitted the UE 502 to send non-encrypted SUPI nor to take any other action. For example, the SN may be a fake network in this case, or the SN may not have access to the HN. The UE 502 therefore abandons the registration with the SN in such a scenario.

It is to be appreciated that the naming of identifiers mentioned herein, e.g., IMSI, SUPI, SUCI, etc., are for illustrative purposes only. That is, an identifier for a UE may have different names or acronyms in different protocols and standards for different communication network technologies. As such, none of the specific names or acronyms given to these identifiers herein are intended to limit embodiments in any manner.

As indicated previously, the embodiments are not limited to the 5G context and the disclosed techniques can be adapted in a straightforward manner to a wide variety of other communication system contexts including, but not limited to, other 3GPP systems and non-3GPP systems which employ identity (e.g., IMSI or equivalent) in the identity request process.

The processor, memory, controller and other components of a user equipment or base station element of a communication system as disclosed herein may include well-known circuitry suitably modified to implement at least a portion of the identity request functionality described above.

As mentioned above, embodiments may be implemented in the form of articles of manufacture each comprising one or more software programs that are executed by processing circuitry of user equipment, base stations or other elements of a communication system. Conventional aspects of such circuitry are well known to those skilled in the art and therefore will not be described in detail herein. Also, embodiments may be implemented in one or more ASICS, FPGAs or other types of integrated circuit devices, in any combination. Such integrated circuit devices, as well as portions or combinations thereof, are examples of “circuitry” as that term is used herein. A wide variety of other arrangements of hardware and associated software or firmware may be used in implementing the illustrative embodiments.

It should therefore again be emphasized that the various embodiments described herein are presented by way of illustrative example only, and should not be construed as limiting the scope of the claims. For example, alternative embodiments can utilize different communication system configurations, user equipment configurations, base station configurations, key pair provisioning and usage processes, messaging protocols and message formats than those described above in the context of the illustrative embodiments. These and numerous other alternative embodiments within the scope of the appended claims will be readily apparent to those skilled in the art.

What is claimed is:

1. A method comprising:
in a serving network of a communication system that also comprises at least one home network associated with a set of subscribers wherein one or more cryptographic key pairs are provisioned for utilization by the subscribers of the home network to conceal subscriber identifiers provided to one or more access points in the serving network of the communication system, an access and mobility management entity of the serving network being configured to perform steps of:
receiving a registration request from user equipment associated with a given subscriber of the home network, the registration request comprising a concealed subscriber identifier for the given subscriber;
computing a random value;
applying a cryptographic hash function to the concealed subscriber identifier and the random value to generate a hash value;
sending the hash value to the home network with an authorization request;
receiving a response to the authorization request from the home network, wherein the response comprises an authorization token; and
sending a message to the user equipment comprising the random value and the authorization token.

2. The method of claim 1, wherein the message sent to the user equipment from the access and mobility management entity further comprises a failure code defining a reason for rejecting the registration request.

3. The method of claim 2, wherein the authorization token received from the home network comprises authorization information and is cryptographically signed by the home network.

4. The method of claim 3, wherein the authorization information indicates an authorized procedure for the user equipment to undertake following the rejected registration request.

5. The method of claim 4, wherein the authorized procedure comprises the user equipment sending another registration request to the serving network with an unconcealed subscriber identifier.

6. The method of claim 4, wherein the authorized procedure comprises the user equipment attempting to access the serving network in a security mode associated with a legacy communication system.

7. The method of claim 4, wherein the authorized procedure comprises the user equipment acting in accordance with network selection guidance provided by the home network.

8. The method of claim 1, wherein the step of sending the hash value to the home network with an authorization request from the home network further comprises sending an identifier of the serving network with the hash value.

9. An article of manufacture comprising a non-transitory computer-readable storage medium having embodied therein executable program code that when executed by a processor causes the processor to perform the steps of claim 1.

10. An apparatus comprising a processor operatively coupled to a memory and configured to perform the steps of claim 1.

11. A method comprising:
in a serving network of a communication system that also comprises at least one home network associated with a set of subscribers wherein one or more cryptographic key pairs are provisioned for utilization by the subscribers of the home network to conceal subscriber identifiers provided to one or more access points in the serving network of the communication system, user equipment associated with a given subscriber of the home network being configured to perform steps of:
sending a registration request to an access and mobility management entity of the serving network, the registration request comprising a concealed subscriber identifier for the given subscriber;
receiving a message from the access and mobility management entity comprising a random value computed by the access and mobility management entity and an authorization token provided by the home network;
computing a hash value using a cryptographic hash function applied to the concealed subscriber identifier and the random value;
checking that the hash value is part of the authorization token provided by the home network; and
proceeding based on authorization information from the authorization token.

12. The method of claim 11, wherein the message received by the user equipment from the access and mobility management entity further comprises a failure code defining a reason for rejecting the registration request.

13. The method of claim 12, wherein the authorization information received from the home network is cryptographically signed by the home network such that the user equipment verifies the authenticity of the authorization information.

14. The method of claim 13, wherein the authorization information indicates an authorized procedure for the user equipment to undertake following the rejected registration request.

15. The method of claim 14, wherein the authorized procedure comprises the user equipment sending another registration request to the serving network with an unconcealed subscriber identifier.

16. The method of claim 14, wherein the authorized procedure comprises the user equipment attempting to access the serving network in a security mode associated with a legacy communication system.

17. The method of claim 14, wherein the authorized procedure comprises the user equipment acting in accordance with network selection guidance provided by the home network.

18. The method of claim 11, wherein the user equipment is further configured to abandon the registration procedure with the serving network when authorization verification fails.

19. An article of manufacture comprising a non-transitory computer-readable storage medium having embodied therein executable program code that when executed by a processor causes the processor to perform the steps of claim 11.

20. An apparatus comprising a processor operatively coupled to a memory and configured to perform the steps of claim 11.

21. A method comprising:
in a serving network of a communication system that also comprises at least one home network associated with a set of subscribers wherein one or more cryptographic key pairs are provisioned for utilization by the subscribers of the home network to conceal subscriber identifiers provided to one or more access points in the serving network of the communication system, an authentication entity in the home network being configured to perform steps of:
receiving a hash value with an authorization request for user equipment associated with a given subscriber from an access and mobility management entity of the serving network, wherein the hash value was computed at the access and mobility management entity using a cryptographic hash function applied to a concealed subscriber identifier associated with the user equipment and a random value computed at the access and mobility management entity;
computing an authorization token comprising authorization information; and
sending a response to the authorization request to the access and mobility management entity of the serving network, wherein the response comprises the authorization token cryptographically signed by the home network.

22. The method of claim 21, wherein the authorization information indicates an authorized procedure for the user equipment to undertake following rejection of the registration request.

23. The method of claim 22, wherein the authorized procedure comprises the user equipment sending another registration request to the serving network with an unconcealed subscriber identifier.

24. The method of claim 22, wherein the authorized procedure comprises the user equipment attempting to access the serving network in a security mode associated with a legacy communication system.

25. The method of claim 22, wherein the authorized procedure comprises the user equipment acting in accordance with network selection guidance provided by the home network.

26. The method of claim 22, further comprising the authentication entity verifying the serving network based on an identifier of the serving network received with the hash value.

27. An article of manufacture comprising a non-transitory computer-readable storage medium having embodied therein executable program code that when executed by a processor causes the processor to perform the steps of claim 21.

28. An apparatus comprising a processor operatively coupled to a memory and configured to perform the steps of claim 21.
